(19) United States
(12) Patent Application Publication
(10) Pub. No.: US 2026/0358219 A1
(43) Pub. Date: Nov. 12, 2026

(54) Test Chamber Arrangement and Capillary Rheometer with a Test Chamber Arrangement

(71) Applicant: Netzsch-Gerätebau GmbH, Selb (DE)

(72) Inventors: Simon Popp, Streitau (DE); Georg Neumann, Schönwald (DE); Christian Müller, Höchstädt (DE)

(21) Appl. No.: 19/655,037

(22) Filed: Apr. 22, 2026

(30) Foreign Application Priority Data
May 6, 2025 (DE) 10 2025 117 307.9

(51) Int. Cl. G01N 11/04; G01B 7/14

(52) U.S. Cl. CPC G01N 11/04; G01B 7/14

(57) ABSTRACT

A test chamber arrangement, in particular in a capillary rheometer, including a test chamber which can be filled with a test mass, can in particular be heated, with a test chamber bottom, a punch arranged in the test chamber in a linearly displaceable manner with a punch rod and a punch tip which is connected to a first end of the punch rod and which exerts pressure on the test mass, and a displacement device accommodating a second end of the punch rod for a displacement of the punch in the test chamber in the direction of the bottom of the test chamber, and a measuring device, which is arranged in the displacement arrangement, is decoupled from the punch and has a defined distance from the second end of the punch rod and is displaceable with the displacement arrangement, for the detection of a punch elongation, wherein a hole extending in the direction of a longitudinal axis of the punch rod between a base of the punch tip and the second end is introduced in the punch rod to accommodate a measuring body extending between the base of the punch tip and the second end, and the measuring device includes a sensor arranged spaced apart relative to the measuring body for the contactless detection of a distance between the measuring body and the measuring device, as well as a capillary rheometer with such a test chamber arrangement.

### TECHNICAL FIELD

The present invention relates to a test chamber arrangement, in particular in a capillary rheometer, as well as a capillary rheometer with such a test chamber arrangement.

### BACKGROUND

Capillary rhometers are used to study the flow behavior and rheological properties of viscous and plastic materials, for example of polymers and highly viscous fluid systems. The material to be examined is passed through a test chamber under defined pressure and as a rule at a constant temperature and can then be extruded from a nozzle. During the flow through the test chamber, measurements of the pressure at the entrance of the capillary and the resulting flow velocity of the material are carried out. By varying the pressure and measuring the associated volume or mass flow rate, the shear rate and shear stress of the material can be determined. Viscosity data can be derived from the relationship between shear stress and shear rate and analyzed at different shear rates. The flow behavior of the test material can thus be shown under process conditions close to reality and a rheological characterization of polymer melts and paste-like systems can be performed. The data obtained on the temperature and shear rate dependence of the viscosity serve as a basis for process planning, such as for example in injection molding and/or extrusion of plastics.

Capillary rheometers with appropriately designed test chambers enable a pVT measurement by determining the volume between a nozzle and the tip of a punch, which is used to pass the test material pressurized through the test chamber and extrude it out of the nozzle. Due to high process temperatures of up to 500 °C and high prevailing pressures, both the punch and the test chamber experience both thermal and mechanical strains, which falsify the measurement result and must be compensated for in the measurement results. One method of measuring strain is to use strain gauges. However, these have only limited applicability with regard to the temperature range. Furthermore, the heating of the punch and thus its temperature-related elongation does not take place uniformly, so that the strain measurement would have to be carried out with great effort by strain gauges attached to several positions. An alternatively purely mathematical compensation of the punch and test chamber strain can only be carried out with great effort, since the heating process is both unsteady and inhomogeneous, i.e. time- and location-dependent. In view of the usually wide temperature and pressure range in rheological measurements, a multidimensional dependence system/matrix is therefore obtained, which would only be sufficiently determined with very high computational effort. Furthermore, a completely new calculation would be required if design changes are made (e.g. change in dimensions, material, geometries of the punch and/or the test chamber). In addition, the mathematical compensation is far less accurate, which is partly due to the large number of joining points of the individual components in the area of the test chamber arrangement under consideration. The heat transfer at these points, the so-called joint conductance or contact resistance, is difficult to determine mathematically and requires experimental verification. However, the joint conductance has a major influence on the heat flow in assemblies and thus also on the temperature therein, which has a direct effect on thermal expansion. On the other hand, both the local heat input is inhomogeneous and also the heating process is unsteady, which means that large parts of the adjacent construction would also have to be simulated exclusively in a mathematical strain compensation. This makes the setup of the simulation very complex and, in common with the transient character, this results in long calculation times. Apart from the thermal influences, there are also mechanical influences, for example the modulus of elasticity is temperature-dependent, which has an influence on the shortening of the punch as a result of the spindle force. These factors would also have to be taken into account in a mathematical compensation, in order to achieve a usable result with theoretical methods.

### SUMMARY

It is therefore the problem of the present invention to create possible ways carrying out a strain compensation in a test chamber of a capillary rheometer in a more cost-effective, simpler and more accurate manner.

According to the invention, this problem is solved in each case by the subject-matter of the independent claims.

According to a first aspect of the invention, a test chamber arrangement is provided, in particular in a capillary rheometer. The test chamber arrangement comprises a test chamber, which can be filled with a test mass and in particular is heatable, with a test chamber bottom, a punch with a punch rod arranged linearly displaceable in the test chamber and a punch tip which is connected to a first end of the punch rod and which exerts pressure on the test mass, and a displacement device which accommodates a second end of the punch rod for a displacement of the punch in the test chamber in the direction of the test chamber bottom and a measuring device arranged in the displacement arrangement, decoupled from the punch, having a defined distance from the second end of the punch rod and displaceable with the displacement arrangement, for detecting a punch strain, wherein a hole extending in the direction of a longitudinal axis of the punch rod between a base of the punch tip and the second end is introduced in the punch rod to accommodate a measuring body extending between the base of the punch tip and the second end, and the measuring device comprises a sensor arranged spaced apart relative to the measuring body for detecting a distance between the measuring body and the measuring device. The detection can be carried out either contactlessly, in particular inductively, or by means of a touching contact, similar to a dial gauge.

According to a second aspect of the invention, a capillary rheometer is provided which is equipped with at least one such test chamber arrangement.

An idea underlying the present invention is to detect strains of the punch tip and the test chamber metrologically, so that the latter can be compensated for mathematically in the obtained measurement data of the test mass. It is thus advantageous to determine the position of the punch tip under pressure and temperature conditions that deviate from the initial conditions. The relative change in position of the contact point between the punch and the test mass can thus be detected without influences of the transfer element, i.e. the displacement device or the surrounding test chamber, such as for example compression of the punch material by pressure, geometric influences caused for example by bending or length change due to temperature gradients, etc. The measuring device for the detection of the position of the punch tip is located for this purpose outside the test chamber and is therefore not influenced by the temperature conditions there. The invention enables strain compensation by constructively arranging a measuring body in the punch rod that is decoupled from the displacement device, wherein the change in position of the measuring body is detected by means of a position or distance sensor. The contact position between the measuring body and the punch tip can thus be determined exactly. A change in the position of the measuring body, which is unaffected by the temperature and pressure conditions at the punch tip, thus essentially corresponds to the actual elongation of the punch tip. This is advantageously achieved by the fact that the measuring body, which stands upright on the base of the punch tip, detects the elongation of the punch, but is arranged decoupled from the punch itself, so that the detected strains can be offset with the information of a displacement measuring system of the displacement device and the measurement accuracy in the capillary rheometer is increased overall. The method of length compensation by measurement offers advantages over computational compensation. With length compensation by measurement, the changes in length are detected directly and in real time, irrespective of whether the strain is thermally or mechanically determined. A further advantage is that measurements are independent of geometric changes in the design or the selection of materials and therefore no calculation parameters need to be adjusted in the event of changes to the device or component structure of the capillary rheometer equipped with the test chamber arrangement according to the invention. Of course, two or more of the test chamber arrangements according to the invention of the same design and function can also be arranged in one measuring device, in a particular capillary rheometer, in order to perform simultaneous measurements and/or to increase the sample throughput of the device.

Advantageous embodiments and developments result from the sub-claims related back to the independent claims as well as from the description with reference to the figures.

According to an embodiment of the test chamber arrangement, a distance of between 0 and 10 mm, in particular between 0 and 5 mm, preferably between 0 and 3 mm, is provided between the sensor and the measuring body, wherein the sensor has a measurement resolution of between 0.001 mm and 0.008 mm, preferably 0.005 mm. The close positioning enables a precise detection of the changes in the length of the measuring body and helps to improve the accuracy of the position determination of the punch tip. The high measurement resolution of the sensor of 0.001 mm to 0.008 mm, preferably at 0.005 mm, enables the detailed detection of even the smallest deformations and strains of the measuring body. This has the advantage that the position of the punch tip can be precisely determined in the event of deformations due to pressure, temperature or mechanical effects and can be reliably compensated for when evaluating the measurement results, in order to achieve higher measurement accuracy in the rheological measurement. The exact detection and compensation of the strain is particularly important in high-pressure and high-temperature environments in capillary rheometers. Overall, therefore, the test chamber arrangement according to the invention increases the measurement accuracy in a structurally simple way and improves the reproducibility of the measurements.

According to a development, the sensor is designed as an inductive distance sensor in the test chamber arrangement according to the invention, wherein the measuring body, at its end facing the distance sensor, has a position marking, in particular a preferably metallic switch flag, which is communicatively connected to each the distance sensor. The inductive distance sensor advantageously enables a contactless or contacting and extremely precise detection of the position of the switch flag, which means that even minimal changes in distance between the sensor and the measuring body can be detected precisely. This contributes to the high accuracy of the position determination of the punch tip. Inductive sensors also have a fast reaction time in dynamic processes, such as rheological measurements. This allows rapid changes in the position or deformations of the punch due to pressure or temperature strain to be detected without delay, as a result of which the real-time analysis of the material properties of the test mass is advantageously improved. The use of a metallic switch flag enables reliable signal processing by the inductive sensor, which simplifies and improves the electronic evaluation and further processing of the measurement data. The detected positions can thus be directly integrated into the data analysis for strain compensation.

According to a development, the measuring body has a lower coefficient of thermal expansion than the punch tip. Since the measuring body expands less markedly than the punch tip with a change in temperature, the position of the punch tip can be detected more precisely. In this way, changes in position that can be traced back to thermal expansion can be reliably detected, computationally compensated for and the measurement accuracy of the devices equipped with the test chamber arrangement according to the invention can be improved in a simple way. In applications such as capillary rheometry, in which high temperatures are common, the measuring body remains dimensionally stable due to its low coefficient of thermal expansion. The reliability of the position measurement is thus increased even with strongly fluctuating or high temperatures, since the measuring body reacts less sensitively to thermal changes. The lower coefficient of thermal expansion of the measuring body enables a more precise determination of the contact point between the punch and the test mass, since thermally induced changes in the length of the punch tip and the test chamber can be compensated for without taking into account the expansion of the measuring body. Advantageously, position measurements are thus more consistent and reproducible.

According to another embodiment, the measuring body is made of a solid material, in particular rod-shaped or a hollow body, in particular as a tube. A rod-shaped measuring body made of solid material offers high mechanical stability and strength. This leads to a reliable transmission of the actual position and thus the elongation of the punch tip without undesirable deformations, resulting in advantages in terms of measurement accuracy, especially under high thermal loads and pressures in the test chamber. The alternative embodiment of the measuring body as a hollow body, in particular as a tube, which is also covered by the invention, allows in contrast a high rigidity with reduced mass, which results in advantages with regard to the reaction time and the sensitivity of the measurements.

In this context, another advantageous embodiment makes provision such that the measuring body is designed as a quartz glass rod or quartz glass tube. The use of quartz glass proves to be advantageous, since quartz glass has a very low coefficient of thermal expansion, i.e. it behaves relatively inert in the presence of temperature fluctuations and shows only minimal changes in volume and length. The shape and position of the measuring body remain stable during the measurement and the associated pressure and temperature changes. Quartz glass can also withstand very high temperatures without changing its structure or shape. This is advantageous particularly in high-temperature applications such as capillary rheometry to ensure precise position and strain measurement of the punch tip even under extreme conditions.

Apart from the above-mentioned embodiment made of quartz glass, alternative materials with comparable coefficients of thermal expansion can also be used for the production of the measuring body. Without limiting the invention to this, these include, for example, glass-ceramic materials, such as materials available under the trade name ZERODUR with comparable thermal stability and temperature resistance to quartz glass, or alloys such as nickel-steel alloys, which are available for example under the trade name INVAR. These materials also have a very low coefficient of thermal expansion and are dimensionally stable with temperature changes. Aluminium silicate glass (e.g. borosilicate glass) can also be used as the material for the measuring body. Aluminium silicate glass also has a low coefficient of thermal expansion and represents a cost-effective yet stable alternative to quartz glass. Silicon carbide (SiC) and glass-carbon, for example, can also be used as further highly stable and low thermally expanding materials for the production of the measuring body.

According to a further embodiment of the test chamber arrangement according to the invention, the displacement device has a spindle drive. A spindle drive allows precise control and detection of the path length and positioning of the punch tip. This is advantageous for the precise displacement measurement of the displacement device, since the spindle drive enables a smooth movement and thus improves the accuracy of positioning in the entire system. Spindle drives also offer a high level of reproducibility, since the positioning remains stable irrespective of load influences and therefore enables the precise positioning of the punch tip even under different loads. The continuous and smooth movement of a spindle drive enables reliable integration into displacement measuring systems, such as linear potentiometers, optical or inductive measuring systems. In this way, precise and continuous measurements of the displacement position can be made, which in conjunction with the test chamber arrangement according to the invention further improves the measurement accuracy. Hydraulic drives, linear motors and piezo motors, for example, can also be considered as alternative drives for the displacement arrangement that do not limit the invention.

According to a further embodiment of the test chamber arrangement according to the invention, a further measuring device arranged outside the test chamber, below the test chamber bottom, is provided for the contactless detection of a test chamber expansion with a further measuring body contacting the test chamber bottom and a further sensor spaced apart relative to the measuring body, wherein the further measuring body extends between the test chamber bottom and the further sensor. Since not only the punch tip, but also the test chamber and its bottom expand with temperature and pressure changes, the additional measuring device enables a precise detection of the elongation of the test chamber bottom and/or an extrusion nozzle or its nozzle base inserted therein in special embodiments of the capillary rheometer. This information can be mathematically combined with the elongation of the punch tip, so that the total elongation of the system can be effectively compensated for and an extremely precise detection of the contact point between the punch and the test mass can be achieved. The contactless detection of the test chamber expansion below the test chamber bottom advantageously ensures that the measuring device itself is not affected by the temperature and pressure in the test chamber. The further measuring body, which contacts the test chamber bottom, thus provides measurement data that enable exact compensation of the thermal expansion of the test chamber. The spatial separation of the measuring devices for the punch tip and the test chamber bottom allows independent detection of the respective strains. This reduces measurement errors, which could occur due to direct mechanical interference, and enables a precise breakdown of the expansion effects, which can then be incorporated separately or combined into the calculation or mathematical correction of the measurement results. Since the measuring device continuously detects the strain of the test chamber bottom, the thermal expansion can be detected dynamically and in real time during the operation of the rheometer and computationally compensated. This is particularly advantageous if the temperatures or pressures in the test chamber interior change during a test cycle, so that a precise position determination of the test chamber bottom or of its pressure- or temperature-dependent expansion is at all times ensured.

According to a development, a distance of between 0 and 10 mm, in particular between 0 and 5 mm, preferably between 0 and 3 mm between the sensor and the measuring body is provided and the sensor has a measurement resolution of between 0.001 mm and 0.008 mm, preferably 0.005 mm. At the bottom, the small distance between the sensor and the measuring body also advantageously allows an extremely precise detection of the strain of the test chamber bottom. Together with the high measurement resolution of the sensor, even the smallest changes in the position of the measuring body due to the expansion of the test chamber or the test chamber bottom are reliably detected, as a result of which the accuracy in the detection and compensation of thermal and mechanical deformations is significantly increased. The high resolution of the sensor also enables a differentiated detection of strains independent of external influences. This leads to an accurate determination of the actual position changes of the test chamber bottom, which contributes to the dynamic compensation of the overall strain and thus increases the measurement accuracy in the operation of the rheometer.

According to another embodiment, the further sensor is designed as an inductive distance sensor and the further measuring body, at its end facing the distance sensor, has a position marking, in particular a metallic switch flag, which is spaced apart relative to the distance sensor and communicatively connected to the distance sensor. The inductive distance sensor advantageously enables a contactless, precise measurement of the position of the metallic switch flag on the further measuring body. The strain of the test chamber bottom without mechanical load is thus accurately detected and the accuracy of thermal strain compensation is improved. Thanks to the inductive measurement and the communicative connection to the switch flag, changes in position at the test chamber bottom can be detected directly and without delay without contact and a dynamic compensation of the overall strain in the rheometer operation can be carried out.

According to a development, a socket is provided for fixing of the measuring body in a position-fixed manner at the test chamber bottom, wherein at least one clamping device, in particular a compression spring, is preferably provided in the socket for the position-fixed fixing of the measuring body. The position-fixed fixing of the measuring body at the test chamber bottom offers the advantage that the measuring body remains in a fixed position even under thermal or mechanical loads, and so a consistent and accurate detection of the test chamber expansion is enabled. Without limiting the invention to this, alternative clamping devices are of course available for position-fixed fixing of the measuring body at the test chamber bottom, which can be used alternatively or in addition in connection with the present invention. Thus, the fixing can take place by means of an elastomer or rubber element, clamping or tensioning screws, by means of magnetic fixing, by clamping rings or bushings or a form-fitting bracket (e.g. by dowel pins). The selection of the appropriate clamping means can be adapted depending on the specific circumstances and requirements of the respective device that the test chamber arrangement according to the invention comprises. It is also possible to use different clamping means in combination with one another.

According to another embodiment, the further measuring body has a lower coefficient of thermal expansion than the test chamber and/or the test chamber bottom. Here, too, it proves to be advantageous that the further measuring body expands less markedly in the presence of temperature changes than the test chamber or its bottom and thus remains stable in its position and shape. This enables a more precise detection of the expansion of the test chamber bottom. The lower thermal expansion of the measuring body ensures that thermally induced changes in the position of the measuring body itself remain minimal, even at high temperatures, so that a high measurement accuracy is achieved. Due to the thermal stability of the measuring body, the actual expansion of the test chamber bottom can be precisely detected and dynamically compensated for computationally.

According to another embodiment, the further measuring body is made of a solid material, in particular rod-shaped or as hollow body, in particular as a tube. A rod-shaped measuring body made of solid material advantageously ensures that a stable and precise detection of the test chamber expansion is achieved. This enables consistent measurement, even under high loads. The embodiment as hollow body (tube) reduces the weight and diminishes the thermal mass, so that the measuring body can react more quickly to temperature changes. This minimizes thermal deformation effects and provides a more accurate compensation for the expansion of the test chamber bottom. In addition, excess material can be drained from the test chamber via the tube. The choice between solid material and a hollow body advantageously enables optimum adaptation to specific operating and measurement requirements.

According to a development, the further measuring body is designed as a quartz glass rod or quartz glass tube in this context. Quartz glass has a very low coefficient of thermal expansion, so the thermally induced deformation of the measuring body is significantly reduced and the position of the measuring body remains stable. Precise detection of the test chamber expansion and reliable compensation of thermal effects are thus advantageously improved. The thermal stability of the quartz glass measuring body ensures an accurate and consistent measurement of the test chamber expansion and the dynamic compensation of expansion in rheometer operation is more precise. Of course, the alternatives to quartz glass described above can also be used here. In order to avoid repetition, reference is made in this context to the explanations in respect of the first measuring body.

According to a development of the capillary rheometer, the test chamber bottom is designed closed or provided with an extrusion nozzle. This advantageously increases flexibility for different application requirements with an otherwise identical embodiment of the test chamber. A closed test chamber bottom allows precise pressure and temperature measurements within the test chamber, while an extrusion nozzle enables the controlled exit of the test mass. This is advantageous for precisely analyzing different flow and deformation properties as required while simultaneously compensating for strain effects. Particularly in combination with a measuring body with a low coefficient of thermal expansion (such as a quartz glass rod), temperature-related metrologically detected deformations of the punch, the test chamber, the test chamber bottom, an extrusion nozzle inserted in the test chamber bottom or its nozzle base can be effectively compensated computationally, thereby increasing the measurement accuracy even under high pressure and temperature conditions.

Of course, embodiments of the capillary rheometer with test chamber arrangements according to the invention which have measuring devices arranged only in the area of the punch rod or punch or only in the area of the test chamber bottom are also covered by the invention.

The above embodiments and developments can be combined arbitrarily with one another, insofar as it is feasible. Other possible embodiments, developments and implementations of the invention include, also not explicitly mentioned, combinations of features of the invention described previously or in the following with regard to the examples of embodiments. In particular, the person skilled in the art will also add individual aspects as improvements or additions to the respective basic form of the present invention.

### BRIEF DESCRIPTION OF THE DRAWINGS

The present invention is explained in greater detail below with the aid of examples of embodiment making reference to the appended figures in the drawings. The figures show:

FIG. 1a a schematic representation of a capillary rheometer according to an example of embodiment of the invention in side view;

FIG. 1b a schematic representation of the capillary rheometer of the example of embodiment from FIG. 1a in cross-sectional representation;

FIG. 2 a schematic representation of a detail of the test chamber arrangement according to a further example of embodiment of the invention in a cross-sectional representation;

FIG. 3 a schematic detailed view of a detail of the test chamber arrangement according to an example of embodiment of the invention in a cross-sectional representation;

FIG. 4 a schematic detailed view of a detail of the test chamber arrangement according to an example of embodiment of the invention in a cross-sectional representation;

FIG. 5 a schematic detailed view of a detail of the test chamber arrangement according to an example of embodiment of the invention in the cross-sectional representation;

FIG. 6a a schematic representation of a capillary rheometer according to a further example of embodiment of the invention in a cross-sectional representation; and

FIG. 6b a schematic representation of a detail of the test chamber arrangement according to the example of embodiment from FIG. 6a of the invention in a cross-sectional representation.

### DETAILED DESCRIPTION

In the figures of the drawing, identical, functionally identical and identically working elements, features and components-unless otherwise stated-are each provided with the same reference numbers.

Although specific embodiments and developments are represented and described in the present case, the skilled person will prefer that a plurality of alternative and/or similar embodiments can replace the specific examples of embodiment presented and described, without departing from the scope of the present invention. In general, this application is intended to cover any modifications or changes of the specific examples of embodiment described herein.

The appended figures are intended to provide a further understanding of embodiments of the invention and serve in connection with the description to explain principles and concepts of the invention. Other examples of embodiment and many of the advantages mentioned arise with regard to the drawings. The drawings are to be understood only as schematic drawings and the elements of the drawings are not necessarily shown true to scale with respect to each other. Directional terminology such as “up”, “down”, “left”, “right”, “above”, “under”, “horizontal”, “vertical”, “front”, “back” and similar indications are used only for explanatory purposes and do not serve to limit the generality to specific embodiments as shown in the figures.

Dashed lines in the figures of the drawings make it clear that the connections between the components connecting the dashed lines do not necessarily have to have physical contact with each other, but can also be wirelessly coupled to each other.

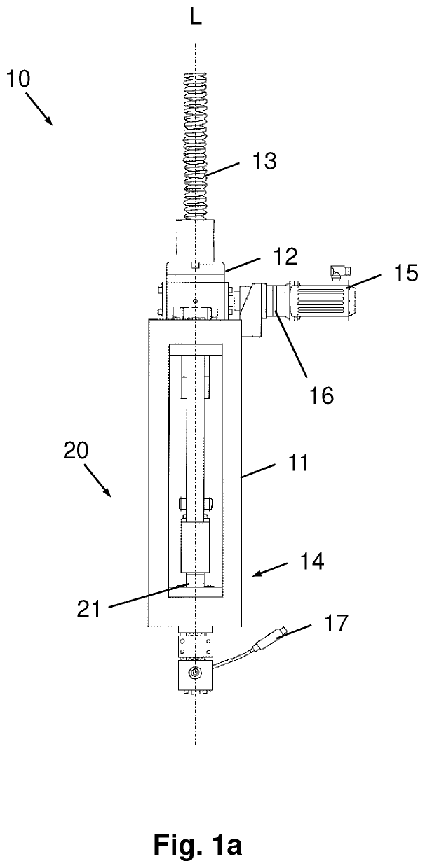

FIG. 1a shows in side view a schematic representation of a part of a capillary rheometer 10 according to an example of embodiment of the invention, which contains test chamber arrangement 20 according to the invention. Schematically shown is a central housing 11, in which the main components of capillary rheometer 10 are housed. The device shown comprises a displacement device 12 which, by means of a spindle drive 13, displaces a punch 14 concealed in FIG. 1a linearly along longitudinal axis L of the device. A motor 15 is mounted on the side of the device, which is connected to spindle drive 13 via a shaft 16 to perform the linear movement. Located at the lower end of housing 11 is test chamber arrangement 20 according to the invention with a pressure measurement sensor 17 for measuring the rheological properties of the test material introduced into test chamber 21 and subjected to pressure via the punch 14. Test chamber 21 is designed heatable.

FIG. 1b shows a schematic representation of the part of capillary rheometer 10 in a cross-sectional representation according to the example of embodiment shown in FIG. 1a. The illustration shows test chamber arrangement 20 and its structure in detail. Test chamber arrangement 20 has a test chamber 21 which can be fixed in the device and which extends in the direction of longitudinal axis L. Test chamber 21 is filled with a test material to be examined, which is liquefied by heating test chamber 21. A punch 14 is introduced into test chamber 21 when the measurement is carried out. Punch 14 comprises a punch tip 18, which rests on the test material and subjects it to pressure as soon as displacement device 12, driven by spindle drive 13, is displaced linearly along longitudinal axis L in the device. Punch 14 has a punch rod 19 which extends the punch tip 18 in the direction of displacement device 12, which can also be called a punch slide.

In the example of embodiment, punch rod 19 is provided with a central hole 22 which extends from upper end 23 of punch rod 19, which is fixed in displacement device 12, up to punch tip 18. However, hole 22 does not pierce punch bottom 24, but ends in punch tip 18. Measuring device 30a, which is decoupled from upper end 23 of punch rod 19, is arranged in displacement device 12. Measuring device 30a comprises an inductive distance sensor 31a, which detects the distance or the change in distance between a measuring body 33a inserted in hole 22 and comprising a switch flag 32a and inductive distance sensor 31a. Measuring body 33a is made of a material with a lower coefficient of thermal expansion than the punch tip 18, for example quartz glass. The arrangement of measuring body 33a within hole 22 of punch rod 19 makes it possible to detect thermal expansions of punch 14 and to compensate for them mathematically, since measuring body 33a expands less with temperature changes than the surrounding material of punch tip 18 and therefore changes its position primarily only due to the elongation of punch tip 18. Measuring body 33a stands on the inside of punch tip 18 on punch bottom 24. From the measured values detected by distance sensor 31a, an elongation of punch 14 or punch bottom 24 can be derived during the rheological measurement, which occurs when punch 14 is subjected to temperature and pressure. The measured values thus detected can be used for strain compensation in the evaluation of the rheological measurement in order to correspondingly correct the measurement results computationally.

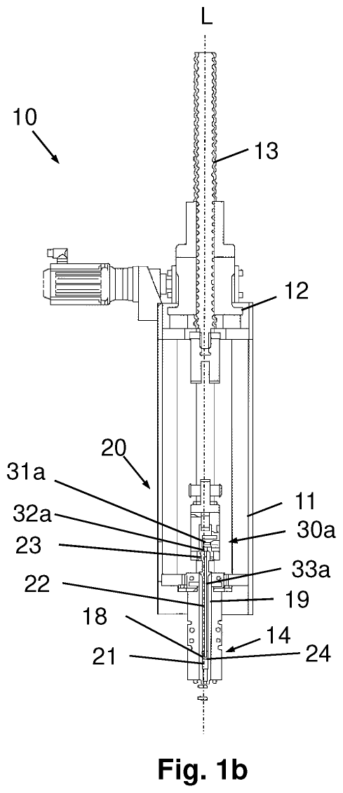

FIG. 2 shows a schematic representation of a detail of test chamber arrangement 20 according to a further example of embodiment of the invention in a cross-sectional representation. In the embodiment according to FIG. 2, a measuring device 30a is arranged on punch 14 and a further measuring device 30b on test chamber bottom 25 for detecting a temperature- and pressure-related elongation on the one hand of punch 14 or punch tip 18 and on the other hand of test chamber bottom 25 or extrusion nozzle 36 inserted there or its nozzle base 35. In the example of embodiment, both measuring devices 30a have inductive distance sensors 31a, b, which are arranged decoupled from the punch 14 or test chamber bottom 25. Distance sensors 31a, b detect a change in the position of measuring bodies 33a, b arranged in punch 14 or at the test chamber bottom 25.

Measuring device 30a assigned to punch 14 is provided integrated into displacement device 12, which is only shown as a detail in FIG. 2, while further measuring device 30b at test chamber bottom 25 comprises a socket 34 fixing further measuring body 33b on the outside on test chamber bottom 25.

Upper end 23 of punch rod 19, which extends punch 14, is fixed in a pressure piece 26, which is integrated in displacement arrangement 12 and which can be pre-tensioned by pressure screws 27. In order to be able to detect the change in length of punch 14 as a result of thermal expansion and compression by compressive force, punch rod 19 is drilled along its longitudinal axis L. In the example of embodiment, a quartz glass rod 28 is inserted into this hole 22, at the upper end of which a steel switch flag 32a is attached, for example glued. Lower end 29 of quartz glass rod 28 stands on the inside of punch bottom 24 in punch tip 18. In the example of embodiment, punch tip 18 is screwed to punch rod 19, wherein a plug-in or snap-in connection is also possible as an alternative. Located above switch flag 32a is inductive distance sensor 31a, which in the example of embodiment is mounted height-adjustable in measuring device 30a. Inductive distance sensor 31a has a high-precision design with a measurement resolution of 0.005 mm in a measuring range of 0 to 3 mm. If the position of punch tip 18 changes, this change in position is detected relative to the position of displacement arrangement 12, also known as the punch slide, and can be compensated.

Similarly, the strains of test chamber 21, also known as a barrel, or test chamber bottom 25 are detected to determine the position of test chamber bottom 25 or nozzle base 35 of an extrusion nozzle 36 inserted in test chamber bottom 25. Further measuring device 30b on test chamber bottom 25 is also equipped with an inductive distance sensor 31b, which is aligned with a metallic switch flag 32b on further measuring body 33b. Further measuring body 33b, which is positioned between test chamber bottom 25 and inductive distance sensor 31b, expands less than test chamber bottom 25 or nozzle base 35 itself, as a result of which the thermal deformation of test chamber bottom 25 or nozzle base 35 can be precisely detected. Inductive distance sensor 31b measures the distance to metallic switch flag 32b and thus enables continuous monitoring and metrological detection of the expansion of test chamber bottom 25 or nozzle base 35.

On the basis of the measured values recorded with the two measuring devices 30a, b or their displacement measuring systems, the distance between punch tip 18 on the one hand and test chamber bottom 25 or nozzle base 35 on the other hand can be precisely determined, which is of great importance especially for pVT measurements, by determining the volume between a nozzle, for example extrusion nozzle 36 and punch tip 18.

Of course, embodiments of capillary rheometer 10 with a test chamber arrangement 20 according to the invention are also possible that have only measuring device 30a, b arranged in the area of punch rod 19 or punch 14 or only measuring device 30a, b arranged in the area of test chamber bottom 25.

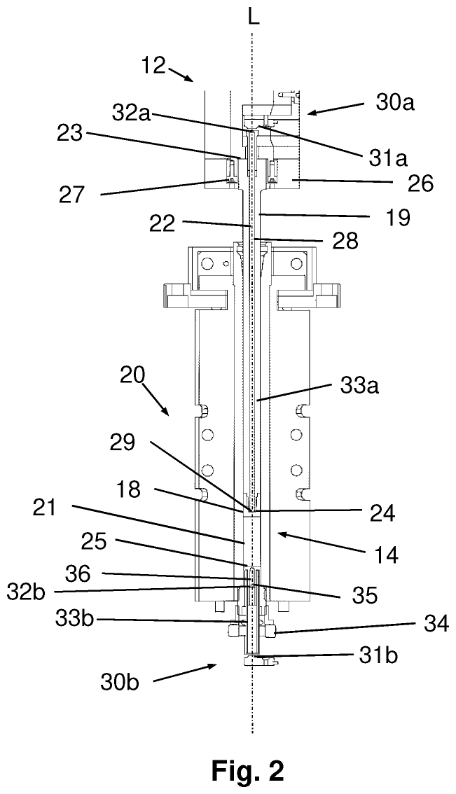

FIG. 3 shows a schematic representation of punch base 24 with measuring body 33a arranged therein, which stands up on punch base 24. Measuring body 33a is positioned in a central hole 22 in punch rod 19 and protrudes through the latter up to punch base 24. Measuring body 33a is made of a material with a lower coefficient of thermal expansion than punch tip 18. Since measuring body 33a expands less than punch tip 18 with temperature changes, a change in position detected by inductive distance sensor 31a in measuring device 30a (see FIG. 2) corresponds to the expansion of punch tip 18 as a result of pressure or temperature effects during the rheological testing process.

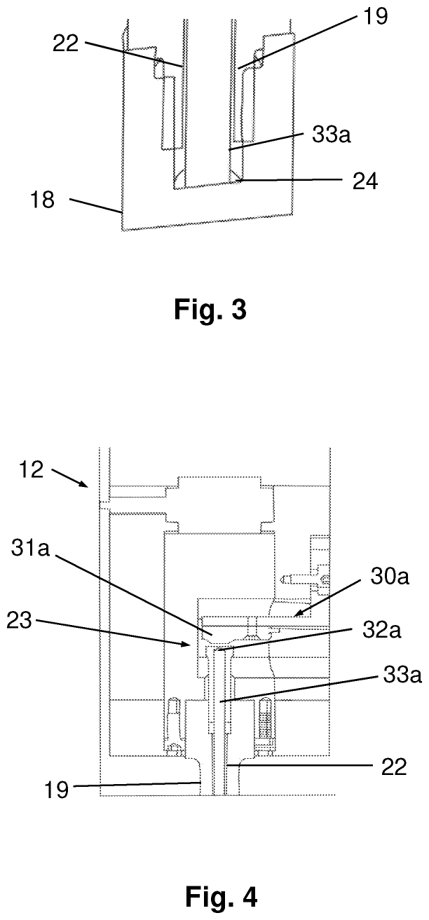

FIG. 4 shows a detailed cross-sectional representation of upper end 23 of punch rod 19, measuring device 30a and a part of displacement device 12 of a capillary rheometer 10 according to an example of embodiment of the invention. Measuring device 30a is integrated at upper end 23 of punch rod 19 to detect the position of measuring body 33a inserted in a hole 22 in punch 14 or punch rod 19. Measuring body 33a is made of a material with a lower coefficient of thermal expansion than punch tip 18 and enables an exact position of punch tip 18 to be determined by measurement. The measured values are used for strain compensation in the evaluation of the rheological test results.

A metallic switch flag 32a facing distance sensor 31a is attached to measuring body 33a and is in communicative connection with inductive distance sensor 31a, which in turn is integrated in displacement device 12, but is decoupled from punch 14 or measuring body 33a. Inductive distance sensor 31a detects the position of metallic switch flag 32a without contact and with high precision. This arrangement makes it possible to detect the smallest changes in the position of punch 18 due to thermal expansion or mechanical loads and then to compensate for them mathematically, for example when determining the volume between a nozzle, for example extrusion nozzle 36, and punch tip 18.

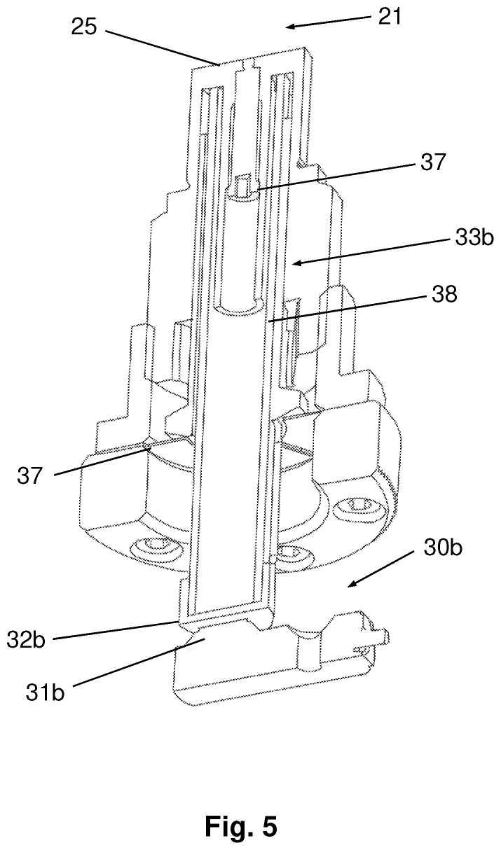

FIG. 5 shows a schematic representation of further measuring device 30b at test chamber bottom 25, according to a further example of embodiment of the invention. Further measuring body 33b is designed as a tube in the example of embodiment and is accommodated in a socket 34 at test chamber bottom 25. Socket 34 is used for the stable position fixing of measuring body 33b and is attached to test chamber bottom 25 via a compression spring 37. The expansion compensation at test chamber bottom 25 is carried out according to the same operating principle as on punch rod 19, even if the structure differs. Instead of a quartz glass rod 28, a quartz glass tube 38 is used here to be able to drain excess material from test chamber 21 or, in the case of a slight adjustment of switch flag 32b, also to measure it during extrusion processes. Compression spring 37 is used to reliably maintain contact between quartz glass tube 38 and test chamber bottom 25 or nozzle base 35. The detection of the change in length is then carried out in the same way as for punch 14, wherein a further inductive distance sensor 31b is provided for this purpose, which detects the change in position of a metallic switch flag 32b attached to further measuring body 33b without contact and thus the elongation of test chamber bottom 25 or nozzle base 37.

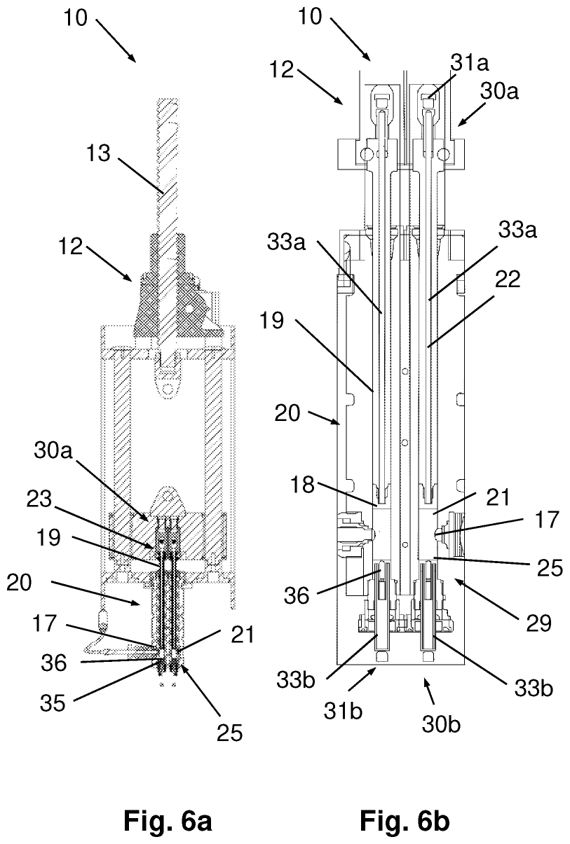

FIG. 6a shows a schematic representation of a capillary rheometer 10 according to a further example of embodiment of the invention in a cross-sectional representation. In the example of embodiment, two test chamber arrangements 20 arranged beside one another are provided. The invention is not limited to this. Of course, more than two of test chamber arrangements 20 according to the invention can also be arranged in one device, in order to increase the sample throughput of the device. The configuration shown enables simultaneous measurements in both test chambers 21 and the detection of strains in test chamber arrangements 20 for strain compensation in the results of the test runs. Both test chamber arrangements 20 are identical in design and each have a punch rod 19 that projects into test chamber 21 and is moved from above via a common displacement device 12 with a single central spindle drive 13. Displacement device 12 controls the pressure exerted on the test mass. The design with two test chambers 21 makes it possible to test different samples in parallel or to perform several series of measurements under identical conditions, as a result of which the comparability of the results is improved.

Each test chamber 21 comprises a measuring device 30a, b as described above, both at upper end 23 of punch rod 19 and at test chamber bottom 25 or nozzle base 35 of an extrusion nozzle 36 provided there, for detecting the temperature- or pressure-related strains in test chambers 21. A pressure measurement sensor 17 is mounted on the side of each test chamber 21 for measuring the rheological properties of the test material introduced into test chamber 21 and subjected to pressure by punch 14.

FIG. 6b shows a schematic representation of a detail of test chamber arrangement 20 according to the example of embodiment in FIG. 6a in a cross-sectional representation. The two test chamber arrangements 20 of capillary rheometer 10 arranged side by side are shown here. Both measuring bodies 33a, b and the arrangement of measuring devices 30a, b with respective inductive distance sensors 31a, b can be seen.

Punch rods 19 are inserted in each test chamber 21 and are driven by common displacement device 12, which move punches 14 in order to apply pressure in a controlled manner via punch tips 18 to the test masses in respective test chambers 21 after they have been melted by heating up test chambers 21. There is a measuring device 30a in each punch rod 19 for the contactless detection of the change in position of measuring bodies 33a inserted in holes 22 in punch rods 19.

Further measuring devices 30b are attached at lower end 29 of each test chamber 21 for recording the thermal and pressure-induced expansion of test chamber bottoms 25 or extrusion nozzles 36 arranged therein. Further measuring device 30b also comprises measuring body 33b and inductive distance sensors 31b. Inductive distance sensors 31b measure the change in position of measuring bodies 33b caused by the expansion of test chamber bottoms 25 and/or extrusion nozzles 36. The recorded values are used to compensate for strain in the evaluation of the results of the rheological material tests in test chambers 21. A pressure measurement sensor 17 is attached to the side of each test chamber 21 for measuring the rheological properties of the test material introduced into test chamber 21 and subjected to pressure by punch 14.

Of course, embodiments of capillary rheometer 10 with test chamber arrangements 20 according to the invention are also possible that only have measuring devices 30a, b arranged in the area of punch rod 19 or punch 14 or only measuring devices 30a, b arranged in the area of test chamber bottom 25.

In the preceding detailed description, various features have been summarized in one or more examples to improve the stringency of the presentation. It should be clear, however, that the above description is merely illustrative in nature, but in no way restrictive. It serves to cover all alternatives, modifications and equivalents of the various features and example of embodiments. Many other examples will immediately and directly become clear to the person skilled in the art due to his technical knowledge in view of the above description.

The examples of embodiment have been selected and described in order to be able to present the principles underlying the invention and its possible applications in practice in the best possible way. This allows experts to modify and use the invention and its various examples of embodiment in the optimum way in relation to the intended use. In the claims as well as in the description, the terms “containing” and “comprising” are used as neutral linguistic terms for the corresponding terms “including”. Furthermore, the use of the term “a” should not in principle exclude a plurality of such described features and components.

1. A test chamber arrangement, a capillary rheometer, comprising:
a test chamber, which can be filled with a test mass, is heatable, and with a test chamber bottom;
a punch arranged in the test chamber in a linearly displaceable manner with a punch rod and a punch tip which is connected to a first end of the punch rod and which exerts pressure on the test mass;
a displacement device which accommodates a second end of the punch rod for a displacement of the punch in the test chamber in the direction of the test chamber bottom; and
a measuring device arranged in the displacement arrangement, decoupled from the punch, having a defined distance from the second end of the punch rod and displaceable with the displacement arrangement, for detecting a punch strain,
wherein a hole extending in the direction of a longitudinal axis of the punch rod between a base of the punch tip and the second end is introduced in the punch rod to accommodate a measuring body extending between the base of the punch tip and the second end, and the measuring device includes a sensor arranged spaced apart relative to the measuring body for detecting a distance between the measuring body and the measuring device.

2. The test chamber arrangement according to claim 1, wherein a distance of between 0 and 10 mm, is provided between the sensor and the measuring body and the sensor has a measurement resolution of between 0.001 mm and 0.008 mm.

3. The test chamber arrangement according to claim 1, wherein the sensor is designed as an inductive distance sensor and the measuring body, at its end facing the distance sensor, has a position marking, in particular a preferably metallic switch flag, which is communicatively connected to the distance sensor.

4. The test chamber arrangement according to claim 1, wherein the measuring body has a lower coefficient of thermal expansion than the punch tip.

5. The test chamber arrangement according to claim 1, wherein the measuring body is made of a solid material, in particular rod-shaped or as hollow body, in particular as a tube.

6. The test chamber arrangement according to claim 1, wherein the measuring body is designed as a quartz glass rod or a quartz glass tube.

7. Test chamber arrangement according to claim 1, wherein the displacement device has a spindle drive.

8. The test chamber arrangement according claim 1, wherein a further measuring device arranged outside the test chamber below the test chamber bottom is provided for the contactless detection of a test chamber expansion, with a further measuring body contacting the test chamber bottom and a further sensor spaced apart relative to the measuring body, and wherein the further measuring body extends between the test chamber bottom and the further sensor.

9. The test chamber arrangement according to claim 8, wherein a distance of between 0 and 10 mm, in particular between 0 and 5 mm, preferably between 0 and 3 mm, is provided between the sensor and the measuring body and the sensor has a measurement resolution of between 0.001 mm and 0.008 mm, preferably 0.005 mm.

10. The test chamber arrangement according to claim 8, wherein the further sensor is designed as an inductive distance sensor, and the further measuring body, at its end facing the distance sensor, has a position marking, in particular a metallic switch flag, which is spaced apart relative to the distance sensor and which is communicatively connected with the distance sensor.

11. The test chamber arrangement according to claim 8, wherein a socket is provided for the position-fixed fixing of the measuring body at the test chamber bottom, and wherein at least one clamping device, in particular a compression spring, is preferably provided in the socket for the position-fixed fixing of the measuring body.

12. The test chamber arrangement according to claim 8, wherein the further measuring body has a lower coefficient of thermal expansion than the test chamber and/or the test chamber bottom.

13. The test chamber arrangement according to claim 8, wherein the further measuring body is made of a solid material, in particular rod-shaped or as a hollow body, in particular as a tube.

14. The test chamber arrangement according to claim 8, wherein the further measuring body is designed as a quartz glass rod or a quartz glass tube.

15. A capillary rheometer with a test chamber arrangement comprising:
a test chamber, which can be filled with a test mass, in particular is heatable, with a test chamber bottom;
a punch arranged in the test chamber in a linearly displaceable manner with a punch rod and a punch tip which is connected to a first end of the punch rod and which exerts pressure on the test mass;
a displacement device which accommodates a second end of the punch rod for a displacement of the punch in the test chamber in the direction of the test chamber bottom; and
a measuring device arranged in the displacement arrangement, decoupled from the punch, having a defined distance from the second end of the punch rod and displaceable with the displacement arrangement, for detecting a punch strain,
wherein a hole extending in the direction of a longitudinal axis of the punch rod between a base of the punch tip and the second end is introduced in the punch rod to accommodate a measuring body extending between the base of the punch tip and the second end, and the measuring device includes a sensor arranged spaced apart relative to the measuring body for detecting a distance between the measuring body and the measuring device.

16. The capillary rheometer according to claim 15, wherein the test chamber bottom is designed closed or provided with an extrusion nozzle.

17. The test chamber arrangement according to claim 2, wherein a distance of between 0 and 5 mm is provided between the sensor and the measuring body.

18. The test chamber arrangement according to claim 17, wherein a distance of between 0 and 3 mm, is provided between the sensor and the measuring body.

19. The test chamber arrangement according to claim 2, wherein the sensor has a measurement resolution of about 0.005 mm.

20. The test chamber arrangement according to claim 19, wherein a distance of between 0 and 5 mm is provided between the sensor and the measuring body.
